(19) United States
(12) Patent Application Publication
(10) Pub. No.: US 2024/0107980 A1
(43) Pub. Date: Apr. 4, 2024

(54) SYSTEMS AND METHODS FOR TRACKING OBJECTS OVER A DISTANCE

(71) Applicant: ZXY Sport Tracking AS, Trondheim (NO)

(72) Inventor: Stian Bo Dahl, Trondheim (NO)

(73) Assignee: ZXY Sport Tracking AS, Trondheim (NO)

(21) Appl. No.: 17/958,851

(22) Filed: Oct. 3, 2022

(51) Int. Cl. A01K 11/00; A01K 29/00; B68C 1/02; H04W 4/021; H04W 4/029; H04W 4/80

(52) U.S. Cl. CPC A01K 11/008; A01K 29/005; B68C 1/02; H04W 4/021; H04W 4/029; H04W 4/80

(57) ABSTRACT

Systems and methods are disclosed for tracking of objects over a distance, including for example, the tracking of horses over the course of a plurality of horse races. The disclosed system can include an ID transmitter that is associated with a particular horse and contains unique identification data. A transponder can be configured to receive the identification data from the ID transmitter and to receive positional data from a plurality of satellites. The transponder may transmit the positional data to a central tracking station in a manner that allows for the association of the positional data with the identification data.

### BACKGROUND

The present disclosure is related to systems and methods for tracking objects over a distance, including for example, the tracking of horses during a race. Currently available systems that are available for tracking events, such as horse races, are inefficient, inaccurate, and costly. The systems and methods disclosed herein address the deficiencies of the available systems.

### BRIEF SUMMARY

In accordance with aspects of the disclosure, a method for tracking a plurality of horses is provided that can include: positioning a transponder within a first coupling area of a first horse, wherein the transponder is configured to communicate via a first communication type and via a second communication type, and wherein the first horse is associated with first identification data; determining that the transponder is within the first coupling area; receiving the first identification data of the first horse via the first communication type based on determining that the transponder is within the first coupling area; transmitting, via the second communication type, positional data of the transponder, while the transponder is attached to the first horse, wherein the positional data is transmitted in association with the first identification data; positioning the transponder within a second coupling area of a second horse, wherein the second horse is associated with second identification data; determining that the transponder is within the second coupling area; receiving the second identification data of the second horse via the first communication type based on determining that the transponder is within the second coupling area; and transmitting, via the second communication type, positional data of the transponder, while the transponder is attached to the second horse, wherein the positional data is transmitted in association with the second identification data.

In accordance with additional aspects of the disclosure, the first communication type may be a near-field communication, the second communication type may be a communication wireless network communication link. The positional data may be acquired from one or more satellites.

In accordance with still additional aspects of the disclosure, positioning the transponder within the first coupling area may further comprise attaching the transponder to an article that is configured to be worn by the first horse. The article may be at least one of a racing bib and a saddle, and the coupling area may comprise an attachment region within at least one of the racing bib and the saddle. At least one of the racing bib and saddle may contain a transmitter that is configured to transmit the first identification data to the transponder.

In accordance with other aspects of the disclosure, determining that the transponder is in the second coupling area may further comprise determining that the transponder is no longer within the first coupling area.

In accordance with still other aspects of the disclosure, receiving the second identification data of the second horse may be further based on determining that the transponder has performed a predetermined event in connection with the positional data that was transmitted in association with the first identification data.

In accordance with yet other aspects of the disclosure, the positional data may be transmitted in association with the first identification data by including a representation of the first identification data within a transmission of the positional data. The positional data may also be transmitted in association with the first identification data by the transponder transmitting the identification data in a first transmission to a central tracking device and transmitting the positional data in a second transmission to the central tracking device.

In accordance with aspects of the disclosure, a system for tracking a plurality of horses may include: a transponder having one or more memory units in communication with one or more processors, and an ID transmitter. The one or more processors may be configured to: receive, from the ID transmitter, a first identification data of a first horse via a first communication type based on a determination that the transponder is within a first coupling area; receive positional data of the transponder while the transponder is attached to the first horse; transmit, via a second communication type, the first identification data and the positional data of the transponder while the transponder is attached to the first horse; receive, from a second ID transmitter, second identification data of a second horse via the first communication type based on a determination that the transponder is within a second coupling area; receive positional data of the transponder while the transponder is attached to the second horse; transmit, via a second communication type, the second identification data and the positional data of the transponder while the transponder is attached to the second horse.

In accordance with other aspects of the disclosure, the determination that the transponder is in the second coupling area further comprises determining that the transponder is no longer within the first coupling area.

In accordance with still other aspects of the disclosure, receiving the second identification data of the second horse may be further based on a determination that the transponder has performed a predetermined event in connection with the positional data that was transmitted in association with the first identification data.

### BRIEF DESCRIPTION OF THE DRAWINGS

FIG. 1 is schematic of a system of transponders and transmitters in accordance with aspects of the disclosure.

FIG. 2 is a schematic of a system including a transponder and transmitter in accordance with aspects of the disclosure.

FIG. 3 is an illustration of a horse having a transponder and transmitter in accordance with aspects of the disclosure.

FIG. 4 is a flow diagram of operations in accordance with aspects of the disclosure.

### DETAILED DESCRIPTION

The current disclosure provides for systems and methods by which transponders can be used to track the position of a plurality of different entities over a distance. In particular, the disclosed systems and methods can be used to provide highly accurate location data for multiple transponders within a local environment, such as a horse race course or a field of a sporting event.

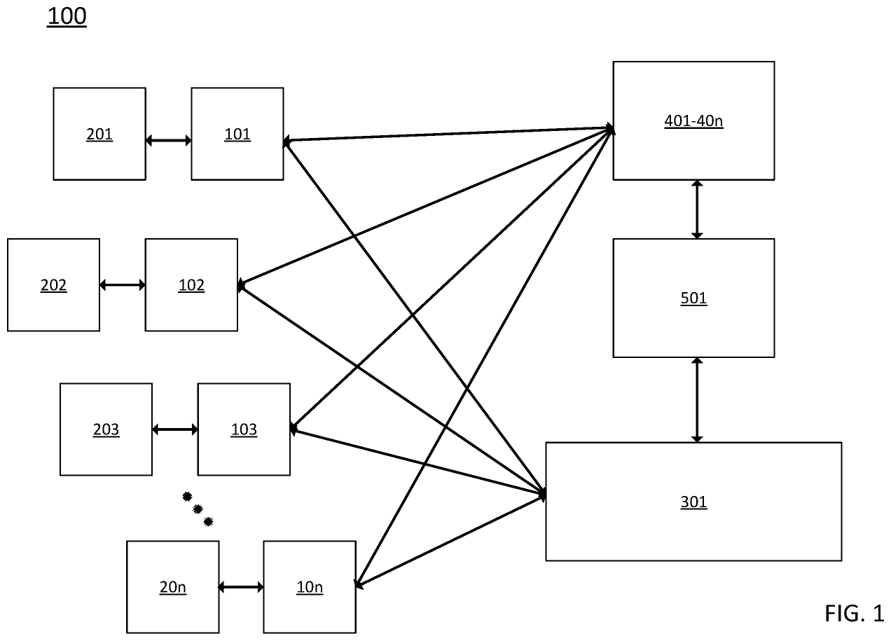

As shown in FIG. 1, a system 100 in accordance with the present disclosure can include transponders 101-10n (in which transponder 101 corresponds to a first transponder, and 10n corresponds to an nth transponder), ID transmitters 201-20n (in which ID transmitter 101 corresponds to a first ID transmitter, and 10n corresponds to an nth ID transmitter), network device 301, satellites 401-40n (in which satellite 401 corresponds to a first satellite and 40n corresponds to an nth satellite), and base station 501. The number of satellites 40n do not need to correspond with the number of transponders 10n and ID transmitters 20n, and for simplicity, satellites 401-40n are illustrated in FIG. 1 as a single block, with each satellite 401-40n being configured to communicate with each transponder 101-10n and to communicate with base station 501. The base station 501 can also be configured to communicate with network device 301 to provide additional satellite-related data.

The transponders 101-10n can be configured to receive identification data from ID transmitters 201-20n. Each transponder 101-10n may be associated with the identification data, and may communicate with satellites 401-40n to receive positional data, which can be used by each transponder 101-10n in connection with determining positional data of each transponder 101-10n. Each transponder 101-10n may also be in communication with one or more network devices 301 that can be configured to process the data received from the transponder and to provide outputs that represent the positional data in connection with the identification data that has been provided by the transponders 101-10n. Network device 301 may be a server, or plurality of servers, that are configured to process and output data in connection with communications with transponders 101-10n. The output of the network device 301 may include associating sets of the positional data with corresponding identification data and comparing each set of positional data with one another.

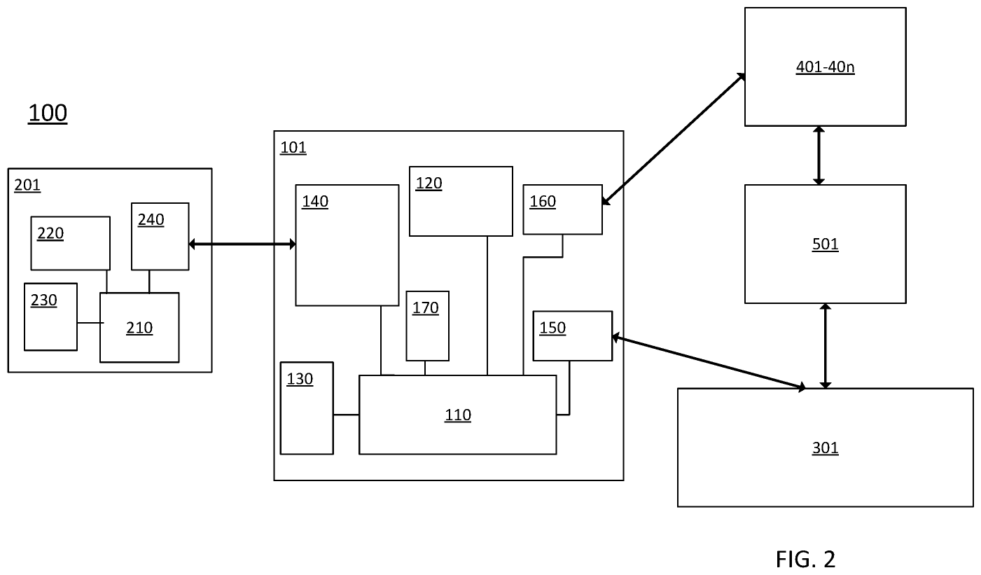

FIG. 2 is a schematic of system 100 in which one transponder 101 and one ID transmitter 201 are shown from the plurality of transponders 101-10n and ID transmitters 201. FIG. 2 shows components that may be included of transponder 101 and ID transmitter 201, and the same or similar components may be included for each of the transponders 101-10n and ID transmitters 201-20n shown in FIG. 1. Transducer 101 may include a processor 110 that is configured to control operations of the transponder. Processor 110 is operatively connected to memory 120 in a manner that allows processor 110 to read data and write data to memory 120. Transducer 101 also includes a first communication interface 140, which is configured to communicate with ID transmitter 201, a second communication interface 150 that is configured to communicate with one or more network devices 301, and a third communication interface 160 for communicating with satellites 401-40n. In addition, transponder may include a user input interface 130, which may include a graphical user interface (GUI), buttons, or other input interfaces for allowing the user to provide commands and adjust settings of transponder 101.

With regard to ID transmitter 201, it may include a processor 210 that is configured to control operations of the transponder. Processor 210 is operatively connected to memory 220 in a manner that allows processor 210 to read data and write data to memory 220. Transducer 201 also includes a communication interface 240. ID transmitter 230 may also include user input interface 230 which may include a graphical user interface (GUI), buttons, or other input interfaces for allowing the user to provide commands and adjust settings of ID transmitter 201.

ID transmitter 201 may be configured to transmit identification data to a transponder, such as transponder 101. For example, identification data may be associated with a particular object, such as a horse. Memory 220 of ID transmitter 201 may be configured to store the identification data, and this identification data may be transmitted from communication interface 240 of ID transmitter 201 to communication interface 140 of transponder 101. The communication interfaces 140 and 240 may be, for example, near field communications (NFC) interfaces that allow for the transmission of data when transponder 101 and ID transmitter 201 are in proximity to one another. In particular, transponder 101 and ID transmitter 201 can be considered in proximity to one another when the communication interfaces 140 and 240 are within a predetermined range for a near field communication signal to be transmitted between the two near field communication interfaces. The communication interfaces 140 and 240 may include an NFC antenna (not shown), as well as circuitry for transmitting and receiving NFC signals via the NFC antenna.

Transducer 101 is configured to receive the identification data from ID transmitter 201 at the communication interface 140, and to store the received identification data in memory 120. Transducer 101 is also configured to communicate with 301 via communication interface 150. Communication interface 150 may be configured for a long-distance communication, such as far field electromagnetic field communication, wireless network communication, cellular network communication, and the like. Accordingly, while FIGS. 1 and 2 show various communication links as being directly between devices, the system may be designed so that the communications between two devices, such as between transponder 101 and network device 301, are transmitted via a plurality of intermediate devices.

Transducer 101 is also configured to acquire positional data, such as data relating to the position, direction of movement, and speed of the transponder 101. This positional data may be acquired from communications with satellites 401-40n via communication interface 160 or from sensor data acquired from sensors 170. Sensors 170 may be sensors that can detect various types of movements, such as an accelerometer, magnetometer, altimeter, gyroscopic sensor, vibrational sensor, or the like. The positional data stored in memory 120 of transponder 101 may be a combination of data received from sensors 170 and data received from external devices, such as satellites 401-40n. While certain communication interfaces are shown as being separate, the system may be configured to that the communication described herein occur using the same communication interface. For example, transponder 101 can be configured so that the communication transponder 101 with satellites 401-40n and network device 301 occur over a single communication interface.

Transducer 101 may transmit identification data from ID transmitter 201, as well as positional data to network device 301, and the processing of the positional data may be performed in a manner that associates the positional data from transponder 101 with the identification data that was provided. Transducer 101 and ID transmitter 201 may be configured to be portable and easily attached to an object without being obtrusive or cumbersome. For example, transmitter 201 may be attached to a horse that is competing in a race, and the transmitter 201 may be configured to store in its memory 220 a unique identifier of the horse as identification data. This identification data may then be transmitted to transponder 101, upon a determination that the transponder 101 has been positioned within a coupling area whereby a transfer of the horse's identification data is transmitted from communication interface 240 to communication interface 140.

Transponder 101 may also be attached at a predetermined position of the horse, whereby upon determining that transponder 101 is in the predetermined position, a coupling between communication interface 240 and communication interfaced 140 occurs. Transmitter 101 may then store the horse's identification information in memory 120, and transmit the identification data to network device 301, in addition to positional data that is collected as the. Network device 301 the positional data for the horse is transmitted from transponder 101 to network device 301. The same may be true for each transponder 101-10n shown in FIG. 1, so that each transponder 101 transmits positional data in a manner that allows the positional data to be associated with unique identification data, which can be used to identify each horse within a race. The system can therefore be configured to allow for transponders to automatically provide positional data that is each associated with a particular horse, from a plurality of horses, without requiring the transponders 101-10n to be manually assigned a particular horse, and without requiring that the transponders 101-10n be assigned prior to being positioned on the horse.

Transducer 101 may be configured to include identification data with the positional data that is transmitted to network device 301. For example, the transmission may contain a header or metadata that includes a representation of the identification data that transponder 101 has received from ID transmitter 201. Network device 301 may then identify the identification data within the transmission from transponder 101 and associate the received positional data with the identification data that was a part of the transmission. The transponder 101 can also be configured to transmit the identification data to network device 301 in a separate transmission from the transmission of positional data. In this example, the network device 301 can be configured to identify a transmission of the identification data from transponder 101 and can also be configured to associate subsequent transmissions from transponder 101 of positional data with the received identification data. In particular, network device 301 may store the received identification data in memory and then associate the positional data with the previously stored identification data.

In addition, network device 301 may be configured to maintain an association between the received positional data from a transponder 101 with received identification data over a predetermined period of time or until identification of a predetermined event. For example, if transponder 101 is being used to track a horse during a race, upon receiving identification data from transponder 101, the network device 301 may continue to associate transponder 101 with the received identification data until it is determined that the horse has completed the race. In addition, while transducer 101 remains within the coupling area for transmitter 201, the transducer 101 may be configured so that it does not receive any positional data or identification data from other devices. Accordingly, the system may be configured so as to prevent the transducer 101 from being unintentionally updated with new identification data during a race. In particular, a transducer 101 may be configured so that it will not update with new identification data, or with incorrect positional data, even if it comes into close enough proximity with another horse's transmitter during a race to receive signals from the other horse's transmitter.

The systems and methods disclosed herein may be configured for high accuracy GNSS localization of the transponders 101-10n. For example, the system may be configured in a manner disclosed in Patent Publication NO20190620A1, which is hereby incorporated by reference, in its entirety. Transponders 101-10n of FIGS. 1 and 2 may include a communication interface 160 that includes a GNSS receiver connected to a GNSS antenna receiving signals from navigation satellites 401-40n, such as GPS, GLONAS, GALILEO and/or BEIDOU for collection of satellite navigation signals. The transponders 101-10n may further allow for processing of raw pseudo range, phase carrier and Doppler measurement/calculations, accordingly providing raw satellite data (RS-data). The transponders 101-10n may also be configured to use interface 140 to receive signals from external sensors of a horse, such as a biometrical measurement device, such as a heart rate monitor, or similar. This sensor data may be transmitted from transponders 101-10n to network device 301 along with the positional data of each transponder 101-10n.

The transponders 101-10n may be configured to transmit the positional data and, if present, sensor data, to network device 301 in real time. In another example, transponders 101-10n may transmit stored data to network device 301, upon receiving a request for such data via communication interface 150. Transponders 101-10n may also be configured to provide a combination of real time processing and post-processing, where the transponders 101-10n both performs storage of the positional data, and if present, sensor data, and transmits data in real time to the network device 301 over a local network data link or radio link, when this link is within reach.

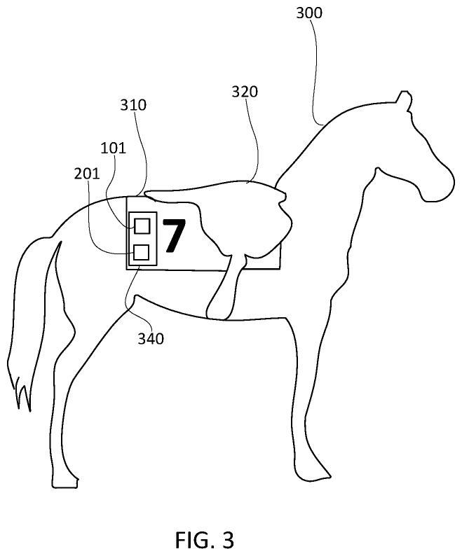

FIG. 3 is an illustration of a horse 300 that is wearing a racing bib 310 and racing saddle 320, wherein a transponder 101 and transmitter 201 have been attached to racing bib 310. Racing bib 301 may include an attachment region 340 that is configured to allow transponder 101 and transmitter 201 to be attached or otherwise connected to bib 310. The transducer 101 and ID transmitter 201 may be attached to an article that can be worn by the horse using various attachment mechanisms, including clips, straps, magnets, velcro, closable pockets, or the like. In accordance with aspects of the disclosure, transmitter 201 may be permanently attached to bib 310, or integrally incorporated into bib 310. For example, transmitter 201 may be sewn into bib 310. Accordingly, any horse wearing bib 310 can be associated with the identification data that is stored within transmitter 201. In addition, transmitter 210 can be configured to determine that a transponder 101 has been attached to or otherwise placed in the proximity of region 340. For example, attachment region 340 may be configured to activate an electrical signal to transmitter 201 when transponder 101 has been placed within or attached to attachment region 340. Transmitter 201 may also be configured to transmit identification data to transponder 101 upon a determination that transponder 101 has been placed within or attached to region 340. As discussed above, the transmission of the identification data from transmitter 201 and transponder 101 may occur using a wireless communication, such as an NFC. In accordance with aspects of the disclosure, coupling between transmitter 201 and transponder 101 may occur based on transponder 101 being positioned within attachment region 340, or similar coupling region, relative to transmitter 201.

The attachment region 340 may be incorporated into other articles that are worn by the horse, For example, the saddle 320 may be configured to include an attachment region 340, so that transmitter 201 and transponder 101 can be communicatively coupled to one another while attached to saddle 320. In another embodiment, the horse 300 may have a bridle, or other articles that are worn during a race, which can be configured to include an attachment region 340 for receiving a transponder 101 and a transmitter 201.

The system configured in accordance with the disclosure allows for an efficient use of components that are needed in connection with the tracking of objects over plurality of events. For example, the transponder 101 shown in FIG. 3 may be removed from horse 300 and attached to a second horse. Upon being attached to the second horse, a second transmitter can be configured to couple with transmitter 101 and transmit identification data that is stored in the second transmitter. Transducer 101 can then store the identification data of the second transmitter, and then provide positional data in association with the identification data of the second transmitter. Returning to FIG. 1, the same can be performed for a plurality of transponders 101-10n, as each transponder 101-10n can be removed from a horse having one of the transmitters 201-20n, and then be attached to a new horse having a different transmitter. Thus each of the transponders 101-10n may each be automatically reassigned to a new identification number by simply removing the transponders 101-10n from a first horse and attaching each of the transponders 101-10n to a new horse.

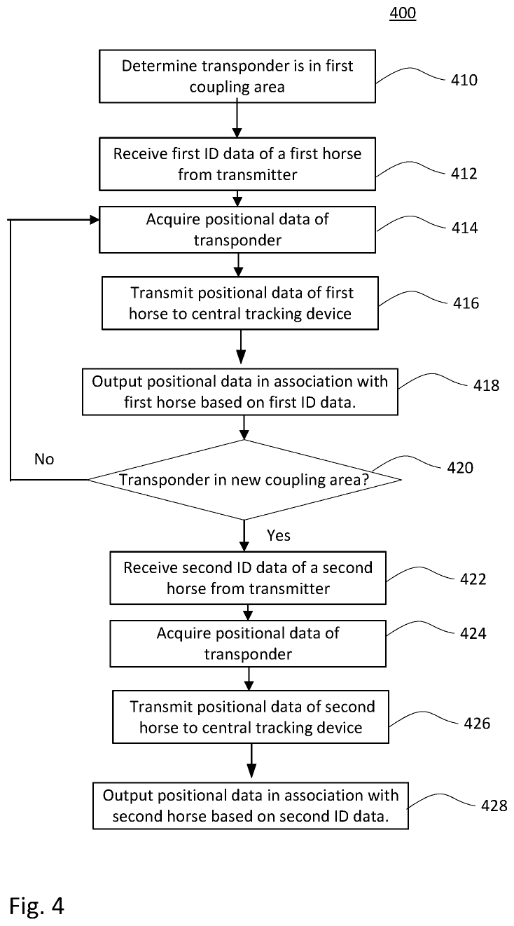

FIG. 4 is a flow diagram 400 that can be performed in accordance with aspects of the disclosure. The operations described in flow diagram 400 may be performed by one or more devices shown in FIGS. 1-3. In accordance with the disclosure herein, the order of the operations may be altered, and some operations may be added or removed. In addition, while flow diagram describes a process whereby identification and positional data correspond to horses, the systems and methods described herein may be used to track other entities.

In operation 410, a determination is made that a transponder has been placed in a first coupling area. For example, as discussed above, transponder 101 may be placed in attachment region 340, as shown in FIG. 3, and transmitter 201 may be configured to determine that transponder 101 is in attachment region 340. In another example, transponder 101 may determine that it is in the coupling area and transmit a coupling signal to transmitter 201, so as to initiate coupling. In operation 412, based on the transponder being in the first coupling area, the transmitter may receive first identification data of a first horse from the transmitter of the first horse. As discussed above, the communication of the identification data may occur via an NFC transmission.

In operation 414, the transponder may acquire positional data of the transponder. For example, as shown in FIG. 1, transponder 101 may acquire positional data from satellites 401-40n, or from other devices. As discussed above this positional data can be acquired by a communication type other than the type of communication that was used to acquire the identification data. The positional data may also include data that is collected from sensors within the transponder or other sensors that are attached to the first horse. The acquired positional data may be stored at a memory of the transponder 101. In operation 416, positional data of the first horse is transmitted to a central tracking device. For example, transponder 101 may transmit the acquired positional data to network device 301, which can be one or more a servers configured to receive and process the positional data via a network, which can be a wireless communication network that is different than the NFC transmission that was used to acquire the identification information.

In operation 418, the central tracking device may process the positional data that it receives from the transmitter and associate that positional data with a particular entity. In one example, the transmission from transponder 101 is associated with the first horse, based on the identification data that was received by the transponder 101. For example, the transmission of the positional data from transponder 101 may include the identification data of the first horse, and this identification data is used by the network device 301 to associate the transmitted positional data with the first horse. The network device 301 may provide an output of the positional data that represents the positional data in connection with the first horse. For example, network device 301 may provide a display of a race track that places the first horse at a position along the race track based on the positional data that was received from transponder 101. In accordance with the systems and methods disclosed herein, the output of the positional data of the plurality of horses can occur in real-time, during the race. The output may include other forms of positional data, including velocity, direction of movement, as well as outputs of one or more sensors that are connected to the first horse.

As set forth in connection with FIG. 1, the disclosed system may include a plurality of transponders 101-10n, and each of these transponders may interact with a transmitter 201-20n and network device 301 in a manner consistent with operations 410-418 of flow diagram 400 shown in FIG. 4. Accordingly, network device 301 can be configured to provide for display the positional data for a plurality of horses within a particular race, with the positional data of each horse being based on the positional data and identification data of each transponder 101-10n. Thus, the output of positional data in operation 418 may also include an output of the relative position of the first horse with respect to other horses within the race. The output positional data may also include a relative position of each horse relative to other geographic or positional markers, such as the finish line of the race track.

In operation 420, a determination is made if the transponder is in a new coupling area. This can occur if the transponder has been removed from the first horse and placed on a second horse. For example, after the first horse has run in a race, the transponder may be used to track the position of a second horse that is running in another race. As long as the transponder remains in the first coupling area, the transponder may continue to perform operations 414-418. However, if the transponder detects that it has been removed from the first coupling area and placed within a second coupling area, operations 422-428 may be performed, whereby the transponder receives, via an NFC transmission, identification data of a second horse from a second transmitter that is attached to the second horse. The transponder may then acquire positional data, including positional data that is acquired as the second horse runs in a race (operation 424), and the transponder may transmit the positional data of the second horse to the central tracking device (operation 426). This transmission, or a previous transmission, may include the identification data of the second horse. The central tracking device may then output positional data in association with the second horse, based on the received positional data and identification data of the second horse. As discussed above, the disclosed system may include a plurality of transponders 101-10n, and each of these transponders may be coupled to a new set of transmitters in connection with a second race. Network device 301 may then receive and process the positional data for a new set of horses in a manner consistent with operations 422-428 of flow diagram 400 for each of the transponders 101-10n.

Using systems and methods disclosed herein, a set of transponders may be used to efficiently track horses over a plurality of races, as the transponders are reused for each race. In some instances, horse races may occur in relatively quick succession, with little time between the races. The systems and methods described herein allow the transponders to be quickly updated between the first race and the second race. In particular, the transponders can be configured to automatically update from being associated with a first horse to being associated with a second horse, without requiring input from a user of either the transponder or the central tracking device. In addition, the same transponders may remain in connection with the central tracking device form a period of time of a first race to a second race, thereby allowing the central tracking device to continue to track the transponder at all times, so as to prevent tampering of the transponders between races. The disclosed system also allows for fewer transponders to be needed over the course of multiple races, as the transponders can be easily and quickly reassigned to new horses based on the automatic communication that is available between the ID transmitters and the transponders.

1. A method for tracking a plurality of horses comprising:
positioning a transponder within a first coupling area of a first horse, wherein the transponder is configured to communicate via a first communication type and via a second communication type, and wherein the first horse is associated with first identification data;
determining that the transponder is within the first coupling area;
receiving the first identification data of the first horse via the first communication type based on determining that the transponder is within the first coupling area;
transmitting, via the second communication type, positional data of the transponder, while the transponder is attached to the first horse, wherein the positional data is transmitted in association with the first identification data;
positioning the transponder within a second coupling area of a second horse, wherein the second horse is associated with second identification data;
determining that the transponder is within the second coupling area;
receiving the second identification data of the second horse via the first communication type based on determining that the transponder is within the second coupling area; and
transmitting, via the second communication type, positional data of the transponder, while the transponder is attached to the second horse, wherein the positional data is transmitted in association with the second identification data;

2. The method of claim 1, wherein the first communication type is a near-field communication.

3. The method of claim 1, wherein positioning the transponder within the first coupling area further comprises attaching the transponder to an article that is configured to be worn by the first horse.

4. The method of claim 3, wherein the article is at least one of a racing bib and a saddle, and wherein the coupling area comprises an attachment region within at least one of the racing bib and the saddle.

5. The method of claim 4, wherein at least one of the racing bib and saddle contains a transmitter that is configured to transmit the first identification data to the transponder.

6. The method of claim 1, further comprising acquiring the positional data from one or more satellites.

7. The method of claim 1, wherein the second communication type is a communication wireless network communication link.

8. The method of claim 1, wherein determining that the transponder is in the second coupling area further comprises determining that the transponder is no longer within the first coupling area.

9. The method of claim 1, wherein receiving the second identification data of the second horse is further based on determining that the transponder has performed a predetermined event in connection with the positional data that was transmitted in association with the first identification data.

10. The method of claim 1, wherein the positional data is transmitted in association with the first identification data by including a representation of the first identification data within a transmission of the positional data.

11. The method of claim 1, wherein the positional data is transmitted in association with the first identification data by the transponder transmitting the identification data in a first transmission to a central tracking device and transmitting the positional data in a second transmission to the central tracking device.

12. A system for tracking a plurality of horses comprising:
a transponder having one or more memory units in communication with one or more processors; and
an ID transmitter;
wherein the one or more processors are configured to:
receive, from the ID transmitter, a first identification data of a first horse via a first communication type based on a determination that the transponder is within a first coupling area;
receive positional data of the transponder while the transponder is attached to the first horse;
transmit, via a second communication type, the first identification data and the positional data of the transponder while the transponder is attached to the first horse;
receive, from a second ID transmitter, second identification data of a second horse via the first communication type based on a determination that the transponder is within a second coupling area;
receive positional data of the transponder while the transponder is attached to the second horse;
transmit, via a second communication type, the second identification data and the positional data of the transponder while the transponder is attached to the second horse.

13. The system of claim 12, wherein the first communication type is a near-field communication.

14. The system of claim 12, the transponder is configured to be attached to an article that is worn by the first horse.

15. The system of claim 14, wherein the article is at least one of a racing bib and a saddle, and wherein the coupling area comprises an attachment region within at least one of the racing bib and the saddle.

16. The system of claim 15, wherein the ID transmitter is configured to be within at least one of the racing bib and saddle.

17. The system of claim 12, wherein the second communication type is a communication wireless network communication link.

18. The system of claim 12, wherein the determination that the transponder is in the second coupling area further comprises determining that the transponder is no longer within the first coupling area.

19. The system of claim 12, wherein receiving the second identification data of the second horse is further based on determination that the transponder has performed a predetermined event in connection with the positional data that was transmitted in association with the first identification data.

20. The system of claim 12, wherein the one or more processors are further configured to, receive the positional data from one or more satellites.
